(19) United States
(12) Patent Application Publication
(10) Pub. No.: US 2015/0248467 A1
(43) Pub. Date: Sep. 3, 2015

(54) REAL-TIME CALCULATION, STORAGE, AND RETRIEVAL OF INFORMATION CHANGE

(71) Applicant: DEEP INFORMATION SCIENCES, INC., Waltham, MA (US)

(72) Inventors: Gerry BUTEAU, Durham, NH (US); Thomas HAZEL, Andover, MA (US)

(21) Appl. No.: 14/626,342

(22) Filed: Feb. 19, 2015

Related U.S. Application Data
(60) Provisional application No. 61/946,481, filed on Feb. 28, 2014.

(51) Int. Cl. G06F 17/30

(52) U.S. Cl. CPC G06F 17/30575; G06F 17/30442; G06F 17/30312; G06F 17/30345

(57) ABSTRACT

A method, system, computer program product, and automated system for calculating a statistic of information change for a collection of information, the method including. A real-time calculation of an actual statistic value of information change is performed for the collection of information. The calculated statistic value is stored and updated when an item is added to or removed from the collection of information to accurately identify the effect of the change to the collection of information on the calculated statistic value. The collection of information may be an information database, and the statistic of information change may comprise cardinality. The statistic of information change may comprise a cardinality vector and be stored such that it can be obtained separately from the collection of information. The calculated statistic value may be used in query optimization for a database query.

### CROSS-REFERENCE TO RELATED APPLICATION

This application claims the benefit of U.S. Provisional Application Ser. No. 61/946,481 entitled “Real-Time Calculation, Storage, and Retrieval of Information Change” and filed on Feb. 28, 2014, which is expressly incorporated by reference herein in its entirety.

### BACKGROUND

The present disclosure relates generally to a method, apparatus, system, and computer readable media for calculating, storing, and retrieving an actual value for a statistic of information change, such as cardinality, associated with a collection of information.

In mathematics, the cardinality of a set is a measure of the “number of elements of the set”. For example, the set A={2, 4, 6} contains 3 elements, and therefore A has a cardinality of 3. In database design, the cardinality relates to a fundamental principle of one data table with respect to another. This measure can be a critical aspect of database management. Database content is not always a set (i.e. not always unique), The uniqueness is what describes database cardinality.

In data modeling, collections of data elements are grouped into “data tables” that contain groups of data field names called “database attributes or columns.” Tables are linked or associated by “key fields.” A “key or index” assigns a field to its “special order table”. A complex data model may involve a large number of related tables. In real world data models, careful design is critical because, as the data grows voluminous, tables linked by keys are used to speed up programmed retrieval of data. If data modeling is poor, even a computer applications system with just a million records causes unacceptable response delay times for end-users.

In SQL (Structured Query Language), the term cardinality refers to the uniqueness of data values contained in a particular column (attribute) of a database table. The lower the cardinality, the more duplicated elements in a column. Thus, a column with the lowest possible cardinality of 1 would have the same value for every row. SQL databases use cardinality to help determine the optimal query plan for a given query.

Traditionally, cardinality is estimated. Cardinality estimates are updated periodically and may drift substantially between estimates. Inaccurate cardinality estimates lead to poor query optimization and inaccurate statistics describing the data.

### SUMMARY

In light of the above described problems and unmet needs as well as others, systems and methods are presented for continuously and efficiently maintaining an actual statistic of information change as items are added, modified, and/or removed from a collection of information. For example, aspects include continuously maintaining an actual cardinality determination as items are added and removed from a database. Aspects presented herein provide various advantages, such as query optimization in database management. A more accurate cardinality determination enables more accurate query optimization. Aspects presented herein provide an actual or exact cardinality determination that may be used, e.g., in determining an optimal query plan.

Additional advantages and novel features in accordance with aspects of the invention will be set forth in part in the description that follows, and in part will become more apparent to those skilled in the art upon examination of the following or upon learning by practice thereof.

### BRIEF DESCRIPTION OF THE DRAWINGS

Various aspects of example systems and methods in accordance with aspects of the present invention will be described in detail, with reference to the following figures, wherein:

FIG. 1 presents an example system diagram of various hardware components and other features, for use in accordance with aspects of the present invention;

FIG. 2 is a block diagram of various example system components, in accordance with aspects of the present invention; and

FIG. 3 illustrates an example method of cardinality determination for the key/value pairs, in accordance with aspects of the present invention;

FIG. 4 illustrates an example addition of 4 key/value mappings and the associated cardinality calculations as each key/value mapping is added, in accordance with aspects of the present invention;

FIG. 5 illustrates the removal of 3 keys and the associated cardinality calculations as each key is removed, in accordance with aspects of the present invention;

FIG. 6 illustrates an example determination of a point of divergence of adjacent keys and the aggregated cardinality at that location, in accordance with aspects of the present invention;

FIG. 7a illustrates an example segmented key space, in accordance with aspects of the present invention; and

FIG. 7b illustrates an additional segment, in accordance with aspects of the present invention.

### DETAILED DESCRIPTION

These and other features and advantages in accordance with aspects of this invention are described in, or will become apparent from, the following detailed description of various example illustrations and implementations.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of systems capable of providing representations of transactions for both disk and memory, in accordance with aspects of the present invention will now be presented with reference to various apparatuses and methods. These apparatuses and methods will be described in the following detailed description and illustrated in the accompanying drawings by various blocks, modules, components, circuits, steps, processes, algorithms, etc. (collectively also interchangeably referred to herein as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented using a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more example illustrations, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), Electrically Erasable Programmable ROM (EEPROM), compact disk (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

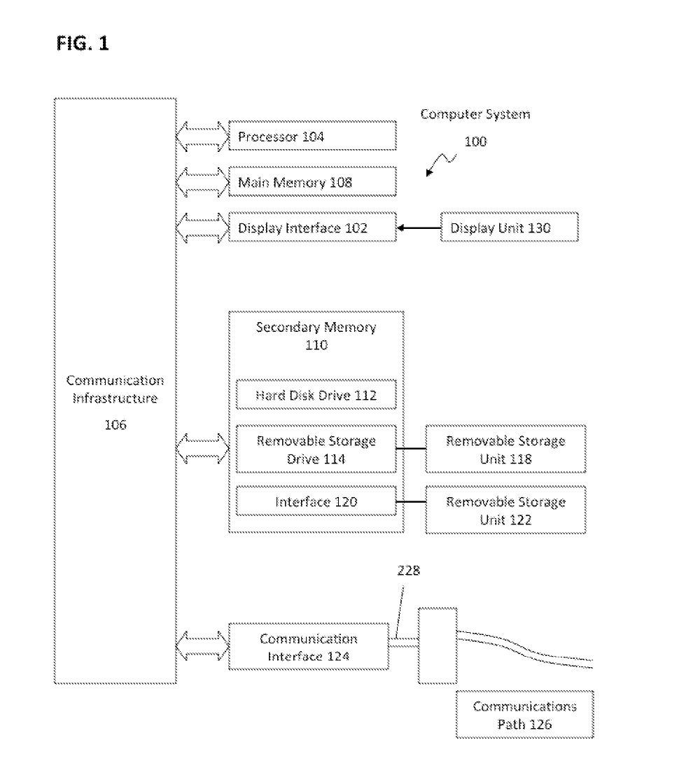

FIG. 1 presents an example system diagram of various hardware components and other features, for use in an example implementation in accordance with aspects of the present invention. Aspects of the present invention may be implemented using hardware, software, or a combination thereof, and may be implemented in one or more computer systems or other processing systems. In one implementation, aspects of the invention are directed toward one or more computer systems capable of carrying out the functionality described herein. An example of such a computer system 100 is shown in FIG. 1.

Computer system 100 includes one or more processors, such as processor 104. The processor 104 is connected to a communication infrastructure 106 (e.g., a communications bus, cross-over bar, or network). Various software implementations are described in terms of this example computer system. After reading this description, it will become apparent to a person skilled in the relevant art(s) how to implement aspects of the invention using other computer systems and/or architectures.

Computer system 100 can include a display interface 102 that forwards graphics, text, and other data from the communication infrastructure 106 (or from a frame buffer not shown) for display on a display unit 130. Computer system 100 also includes a main memory 108, preferably RAM, and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc., which is read by and written to removable storage drive 114. As will be appreciated, the removable storage unit 118 includes a computer usable storage medium having stored therein computer software and/or data.

In alternative implementations, secondary memory 110 may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an EPROM, or programmable read only memory (PROM)) and associated socket, and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of signals 128, which may be electronic, electromagnetic, optical or other signals capable of being received by communications interface 124. These signals 128 are provided to communications interface 124 via a communications path (e.g., channel) 126. This path 126 carries signals 128 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 114, a hard disk installed in hard disk drive 112, and signals 128. These computer program products provide software to the computer system 100. Aspects of the invention are directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features in accordance with aspects of the present invention, as discussed herein. In particular, the computer programs, when executed, enable the processor 110 to perform various features. Accordingly, such computer programs represent controllers of the computer system 100.

In an implementation where aspects of the invention are implemented using software, the software may be stored in a computer program product and loaded into computer system 100 using removable storage drive 114, hard drive 112, or communications interface 120. The control logic (software), when executed by the processor 104, causes the processor 104 to perform various functions as described herein. In another implementation, aspects of the invention are implemented primarily in hardware using, for example, hardware components, such as application specific integrated circuits (ASICs). Implementation of the hardware state machine so as to perform the functions described herein will be apparent to persons skilled in the relevant art(s).

In yet another implementation, aspects of the invention are implemented using a combination of both hardware and software.

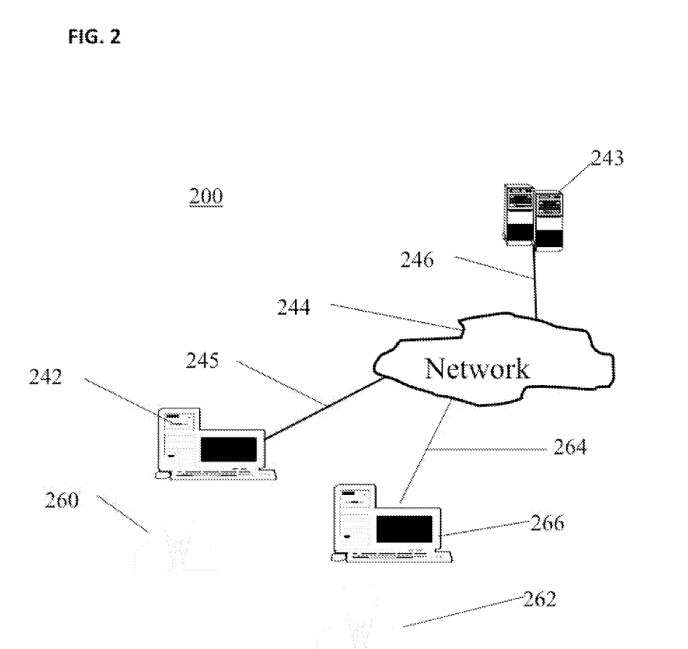

FIG. 2 is a block diagram of various example system components, in accordance with aspects of the present invention. FIG. 2 shows a communication system 200 usable in accordance with the aspects presented herein. The communication system 200 includes one or more accessors 260, 262 (also referred to interchangeably herein as one or more “users” or clients) and one or more terminals 242, 266. In an implementation, data for use in accordance with aspects of the present invention may be, for example, input and/or accessed by accessors 260, 264 via terminals 242, 266, such as personal computers (PCs), minicomputers, mainframe computers, microcomputers, telephonic devices, or wireless devices, such as personal digital assistants (“PDAs”) or a hand-held wireless devices coupled to a server 243, such as a PC, minicomputer, mainframe computer, microcomputer, or other device having a processor and a repository for data and/or connection to a repository for data, via, for example, a network 244, such as the Internet or an intranet, and couplings 245, 246, 264. The couplings 245, 246, 264 include, for example, wired, wireless, or fiberoptic links.

Query optimization relies heavily upon accurate cardinality information. Specifically, cardinality determines the selectivity of an index according to the following equation:

Selectivity of index=cardinality/(number of records)*100%

Generally, the higher the selectivity the better/more efficient the index. Or, stated another way, more selective indexes are generally favored over less selective indexes during query optimization. Indexes with very low selectivity may not be used at all.

Thus, the more accurate the cardinality determination, the more accurate the selectivity calculation and thus the resulting index selection. Traditional solutions maintain cardinality estimates. These estimates are updated periodically and may drift substantially between estimates. Inaccurate estimates are problematic during queries resulting in poor performance due to irrelevant searching. Exact cardinality determination produces the most accurate and optimal selectivity calculation possible. Aspects presented herein enable accurate calculation, storage, and retrieval of cardinality. A calculation of an “actual” cardinality as used herein means an exact cardinality as opposed to an estimate of the cardinality.

When information is added to a database, it may be added using a key. This information may relate to a single column in the database or to multiple columns in a relational database. If a new key, different than those already included in the database, is added, the cardinality statistic is adjusted to incorporate the increased cardinality. If such a key were removed, the cardinality statistic would be decremented to reduce the statistic. An accurate, or exact, cardinality statistic is continually maintained. A key may also be a composite key. This approach enables the cardinality for the database to be captured and stored in real-time, whereas past cardinality calculations merely involved a random estimation.

The aspects presented herein can be applied to any set of ordered information. This ordered information may be stored in a tree structure, one example of which is a Cache-Ahead Summary Indexing (CASI) trees. Thus, although examples are given applying aspects to a CASI tree, the aspects are not limited in application to such a structure of ordered information. The ordered information may store, e.g., ordered key to value mappings. Keys may be composed of one or many key parts (i.e. it is a composite key). Cardinality may be determined for each key and its key parts. An example of sample Key/Value mappings is:

(5,Z,3)->0

(7,C,8)->1

(7,A,6)->2

(7,C,4)->3

(5,O,1)->4

(5,Z,2)->5

(5,A,5)->6

(5,A,6)->7

(5,Z,1)->8

(7,A,5)->9

In one example implementation, each of the keys are composed of 3 key parts. Table 1 contains the ordered key/value mappings with the key parts broken out.

TABLE 1

| Key | | | |
|---|---|---|---|
| Key Part 1 | Key Part 2 | Key Part 3 | Value |
| 5 | A | 5 | 6 |
| 5 | A | 6 | 7 |
| 5 | O | 1 | 4 |
| 5 | Z | 1 | 8 |
| 5 | Z | 2 | 5 |
| 5 | Z | 3 | 0 |
| 7 | A | 5 | 9 |
| 7 | A | 6 | 2 |
| 7 | C | 4 | 3 |
| 7 | C | 8 | 1 |

Cardinality may be determined for each of the key parts and keys.

The cardinality of the full key is, e.g., 10. In Table 1, the cardinality of Key Part 1 is 2, Key Part 2 is 4 and Key Part 3 is 7. Finally, the cardinality of a key composed of Key Part 1 and Key Part 2 (in that order) is 5. Likewise, the cardinality of Key Part 1, Key Part 2 and Key Part 3 (in that order) is the full Key and is 10.

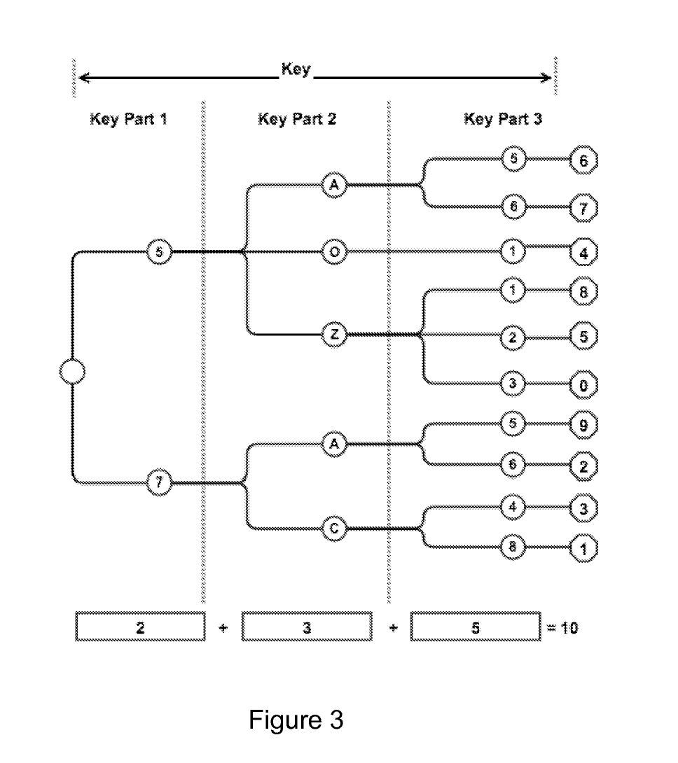

FIG. 3 illustrates an example method of cardinality determination for the above key/value pairs.

### Key/Value Pair Addition

As each key/value pair is added to the CASI tree cardinality is updated.

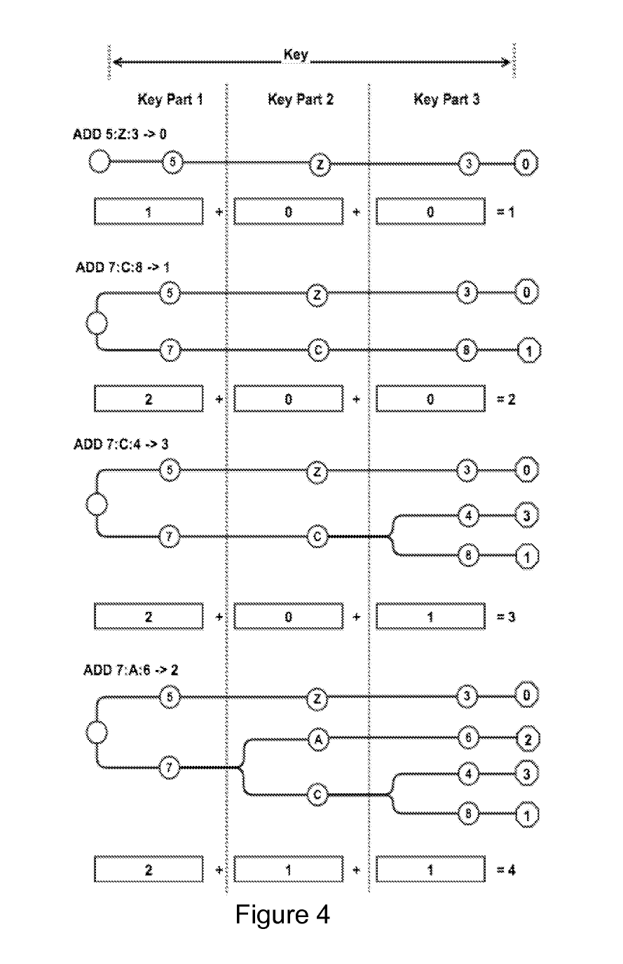

FIG. 4 illustrates an example addition of 4 key/value mappings and the associated cardinality calculations as each key/value mapping is added.

In this example, each key part has an independent cardinality value and these values are considered as a vector of values. Cardinality is determined for unique combinations of key parts from left to right. Thus obtaining the cardinality of key part 2 is thought of as the cardinality of unique combinations of key part 1 followed by key part 2. The sum of the cardinality values up to the desired number of key parts produces the cardinality of those key parts combined.

Whenever a unique key is added, only one cardinality value is adjusted. The value to be adjusted (e.g., incremented) is determined by where (e.g., which key part) the added key diverges from the existing keys. This process is demonstrated in the figure.

When a key/value pair is added (e.g. (5,Z,3)->0) to an empty CASI tree the diverging key part is the first key part, thus the first element of the cardinality vector is incremented and its value becomes 1. Once divergence is discovered, key part comparisons stop, thereby short-circuiting the cardinality calculation as soon as possible.

Next, a key/value pair of (7,C,8)->1 is added. As 7 is not equal to 5, divergence is discovered in the first key part and the first element of the cardinality vector is incremented.

A key/value pair of (7,C,4)->3 is added next. In this case key part 1 and key part 2 already exist in the CASI tree, so the first divergence is found at key part 3, where 8 is not equal to 4. Thus, the cardinality vector cell representing key part 3 is incremented.

Finally, a key/value pair of (7,A,6)->2 is added. In this case the divergence is at key part 2 (i.e. A is not equal to C) and the cardinality vector cell representing key part 2 is incremented.

### Key/Value Pair Update

When an existing key/value pair is updated within a CASI tree, cardinality does not change. Consider the case of updating (7,A,6)->2 to (7,A,6)->4 in the above example. Each key part matches, and thus, there is no divergence. Without divergence, no cell of the cardinality vector is updated, and no cardinality change is present.

### Key/Value Pair Removal

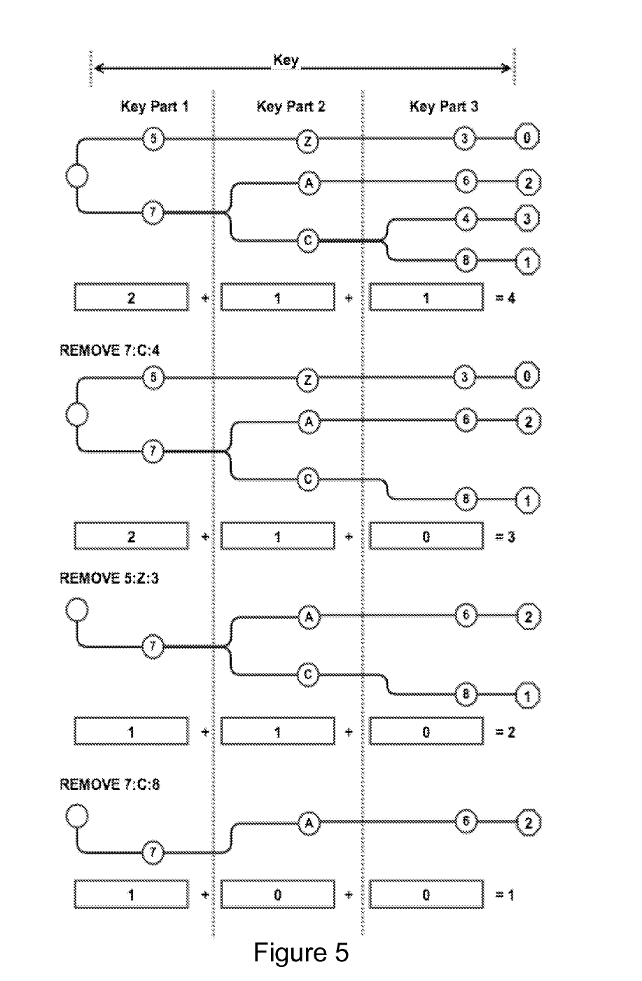

As each key/value pair is removed from the CASI tree cardinality is updated. FIG. 5 illustrates the removal of 3 keys and the associated cardinality calculations as each key is removed.

When a key and its associated value are removed from a CASI tree, the key/value is looked up. If it exists, it is removed. As each key is removed, the appropriate cardinality element is decremented. This operation is the opposite of the addition operation. The cardinality element to be decremented is determined by finding the rightmost (i.e., deepest/longest) key part that diverges from the previous key and the next key. This test may also be considered a longest matching prefix test.

For example, the above diagram depicts the removal of three keys. The first key removed is (7,C,4). When (7,C,4) is removed, the previous key (7,A,C) and the next key (7,C,8) are examined. In this examination, it is determined if the previous key matches at 7 and the next key matches at (7,C). Thus, the longest matching prefix is (7,C) (i.e., the divergence occurs at the third key part), and the cardinality element representing the third key part is decremented.

Next, key (5,Z,3) is removed. In this case, the previous key is None and the next key is (7,A,6). A None key always diverges at the first key part. Furthermore, key (5,Z,3) diverges from (7,A,6) at the first key part. In both cases, the longest matching prefix is None (i.e., 0), and the cardinality element representing the first key part is decremented.

Finally, key (7,C,8) is removed. In this case, the previous key is (7,A,6) and the next key is None. The longest matching prefix is associated with the previous key and is (7). Thus, the cardinality element associated with the second key part is decremented.

### Segment Aggregation

Segments subdivide a key space. As used herein, a “segment” comprises a grouping of a unit of information to be managed, e.g., each segment having at least a first key, a last key, and a cardinality vector. The segment unit may be of any suitable size, and the segment unit size may be selected based on any desired criteria. Each segment maintains an independent cardinality calculation as specified in the previous sections. Determination of the cardinality for the overall key space requires an aggregation and adjustment of each segment's cardinality.

Since each segment is non-overlapping, the aggregation of cardinalities involves simple addition. However, an adjustment to this aggregation is performed by considering the last key of a previous segment and the first key of the next segment (i.e., the point at which the segments are merged). Cardinality adjustment is performed by looking for the new point of divergence between the last key of the previous segment and the first key of the next segment.

When a segment is created and added to the CASI tree by its first key, the point of divergence is always the first element of the cardinality vector. Thus, the first element of the aggregated cardinality vector may be decremented unconditionally if desired. Next, the point of divergence of the last key of the previous segment and the first key of the next segment is determined (i.e., the longest matching prefix), and the aggregated cardinality element at that location is incremented.

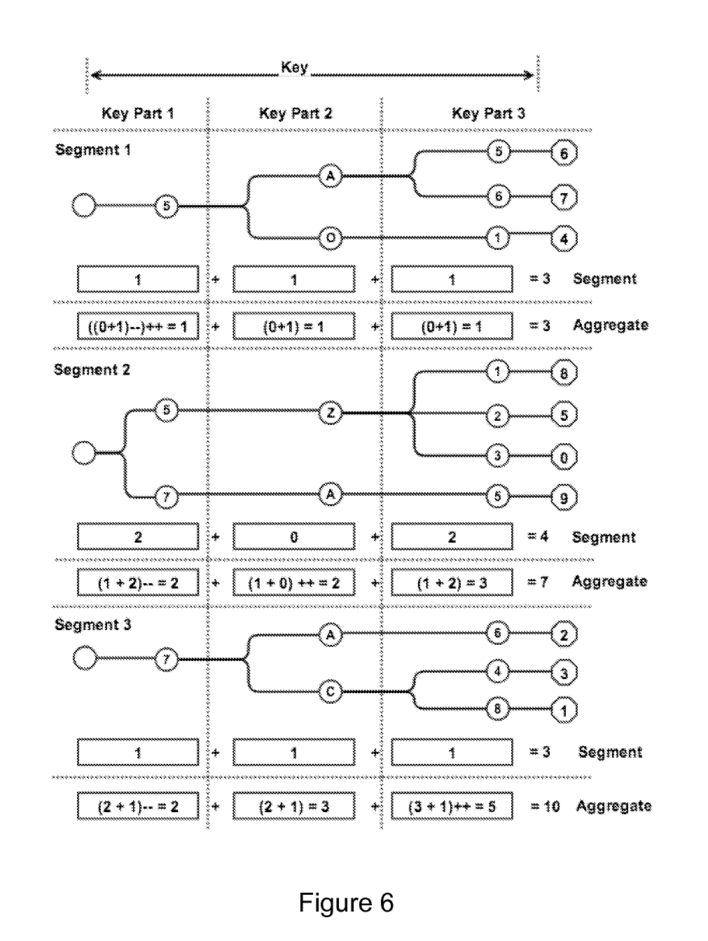

FIG. 6 illustrates aspects of this process. The first segment in FIG. 6 may be considered to be preceded by a NULL segment (i.e., a non-existent segment). Furthermore, this NULL segment has a NULL first key and a NULL last key, along with a cardinality vector with elements of value 0. The aggregation (i.e., sum) of the NULL segment's cardinality vector and Segment 1's cardinality vector is 1:1:1. Unconditionally decrementing the first element produces an aggregate vector of 0:1:1. The point of divergence between the NULL segment's NULL last key and Segment 1's first key (i.e., (5,A,5)) is the first element of the cardinality vector. Incrementing the first element of the aggregate cardinality vector produces 1:1:1.

The second segment is preceded by the first segment in FIG. 6. The first segment has a last key of (5,O,1) and the second segment has a first key of (5,Z,1). The longest matching prefix is (5) and the point of divergence indicates the second element of the cardinality vector must be incremented. Thus, the aggregate cardinality vector is calculated as follows:

1. sum the cardinality vectors; 1:1:1+2:0:2=3:1:3
2. decrement the first element; 3−:1:3=2:1:3
3. increment the second element; 2:1++:3=2:2:3

The third segment with a first key of (7,A,6) is preceded by the second segment with a last key of (7,A,5). The longest matching prefix is (7,A), and the point of divergence indicates the third element of the cardinality vector must be incremented. The aggregate cardinality vector is calculated as follows:

1. sum the cardinality vectors; 2:2:3+1:1:1=3:3:4
2. decrement the first element; 3−:3:4=2:3:4
3. increment the third element; 2:3:4++=2:3:5

Thus, the cardinality vector calculated for a segmented key space matches the cardinality calculated for the original, non-segmented key space.

### Segment Addition

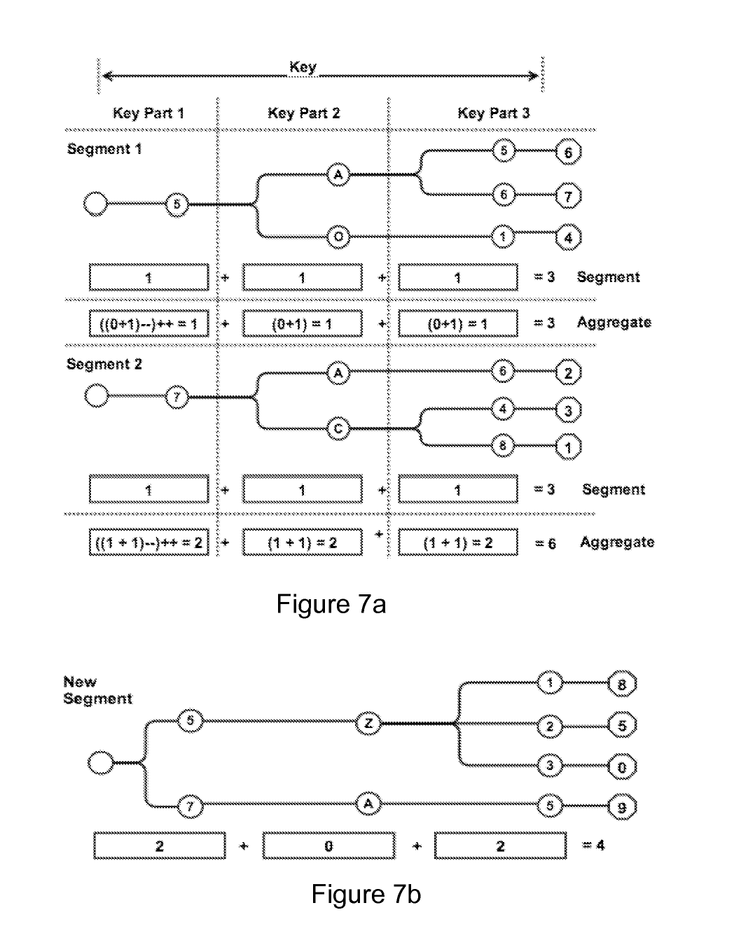

The addition of a segment increases the cardinality of the key space. Considering the segmented key space in FIG. 7a and the addition of the segment from FIG. 7b, Segments are non-overlapping. The new segment fits between Segment 1 and Segment 2 of FIG. 7a.

### Segment Removal

Likewise, the removal of a segment decreases the cardinality of the key space.

### Segment Split

As segments become too large or too small, the segment may be merged or split. The determination regarding merging or splitting segments may be based, e.g., on a mathematical determination of a cost to store, write, and/or read a segment. Alternately, the determination may be based at least in part on whether there are too many segments.

Splitting a segment does not change the cardinality of the key space. However, when a single segment is split into two segments, each of the resulting segments must have their individual cardinality vectors updated to reflect the cardinality of each new segment.

### Segment Merge

Merging segments does not change the cardinality of the key space. However, when segments are merged, the resulting segment must have its cardinality vector adjusted to reflect the cardinality of merged segments.

### Segment Summarization

Segments may summarize other segments. For the purposes of cardinality determination, a segment may be summarized by its first key, last key and cardinality vector. A segment summarizing a group of segments or summary segments then has enough information to calculate its cardinality (i.e., the cardinality of the segments it contains) using the process described above. This process may be continued to an arbitrary number of hierarchical levels.

Although examples are presented herein for the calculation of cardinality for key/value pairs, the concept presented herein may be used to determine an exact value for any statistic of information change. The concept is not constrained to informational databases, but may be applied to any collection of information. It may be applied both on a macro and on a micro level.

Thus, aspects may include a computer assisted method for calculating a statistic of information change for a collection of information, the method including: performing a real-time calculation of an actual statistic value of information change for the collection of information; storing the calculated statistic value; and updating the calculation of the statistic value when an item is added to or removed from the collection of information to accurately identify the effect of the change to the collection of information on the calculated statistic value. Although the term “statistic of information change” is used, this is a statistic regarding the information itself, e.g., such as the cardinality of the information. This is different than information change such as updated per second, etc.

While aspects of this invention have been described in conjunction with the example implementations outlined above, various alternatives, modifications, variations, improvements, and/or substantial equivalents, whether known or that are or may be presently unforeseen, may become apparent to those having at least ordinary skill in the art. Accordingly, the example illustrations, as set forth above, are intended to be illustrative, not limiting. Various changes may be made without departing from the spirit and scope hereof. Therefore, aspects of the invention are intended to embrace all known or later-developed alternatives, modifications, variations, improvements, and/or substantial equivalents.

Additional details regarding cardinality can be found at, e.g., Wikipedia at http://en.wikipedia.org/wiki/Cardinality, the entire contents of which are herein incorporated by reference. Additional details regarding Cardinality in data modeling can be found at Wikipedia, e.g., at http://en.wikipedia.org/wiki/Cardinality_(data_modeling) and http://en.wikipedia.org/wiki/Cardinality_(SQL_statements), the entire contents of each of which are herein incorporated by reference.

What is claimed is:

1. A computer assisted method for calculating a statistic of information change for a collection of information, the method including:
performing a real-time calculation of an actual statistic value of information change for the collection of information;
storing the calculated statistic value; and
updating the calculation of the statistic value when an item is added to or removed from the collection of information to accurately identify the effect of the change to the collection of information on the calculated statistic value.

2. The method of claim 1, wherein the collection of information comprises an information database.

3. The method of claim 2, wherein the statistic of information change comprises cardinality.

4. The method of claim 2, wherein the calculated statistic value comprises a cardinality vector, and wherein the cardinality vector is stored such that it can be obtained separately from the collection of information.

5. The method of one of claim 3 and claim 4, further comprising:
using the calculated statistic value in query optimization for a database query.

6. The method of claim 1, wherein performing the real-time calculation of the actual statistic value includes:
calculating the actual statistic value for each of a plurality of segments comprised in the collection of information; and
aggregating the calculations for each of the plurality of segments.

7. The method of claim 6, wherein the statistic is cardinality, and wherein aggregating of the actual cardinality includes:
adding the cardinality for each of the plurality of segments; and
accounting for a point of divergence between adjacent segments.

8. The method of claim 1, wherein the collection of information comprises a set of ordered information that includes a plurality of key/value pairs, and wherein the statistic comprises cardinality, the method further comprising:
adding a key/value pair to the set of ordered information, each key/value pair in the set of ordered information having a plurality of keys;
determining at which key the key/value pair diverges from the preceding or following keys;
incrementing the calculated cardinality value at the determined key part; and
storing the incremented cardinality value.

9. The method of claim 8, further comprising:
removing a second key/value pair from the set of ordered information;
determining a point at which the second key/value pair diverges from proximally located key/value pairs in the set of ordered information;
decrementing the calculated cardinality value at the determined point; and
storing the decremented cardinality value.

10. An automated system calculating a statistic of information change for a collection of information, the system comprising:
means for performing a real-time calculation of an actual statistic value of information change for the collection of information;
means for storing the calculated statistic value; and
means for updating the calculation of the statistic value when an item is added to or removed from the collection of information to accurately identify the effect of the change to the collection of information on the calculated statistic value.

11. The system of claim 10, wherein the collection of information comprises an information database, and wherein the statistic of information change comprises cardinality, the system further comprising:
means for using the calculated statistic value in query optimization for a database query.

12. The system of claim 10, wherein the means for performing the real-time calculation of the actual statistic value calculates the actual statistic value for each of a plurality of segments comprised in the collection of information and aggregates the calculations for each of the plurality of segments.

13. The system of claim 12, wherein the statistic is cardinality, and wherein aggregation of the actual cardinality includes:
adding the cardinality for each of the plurality of segments; and
accounting for a point of divergence between adjacent segments.

14. The system of claim 10, wherein the collection of information comprises a set of ordered information that includes a plurality of key/value pairs, and wherein the statistic comprises cardinality,
wherein the means for performing add a key/value pair to the set of ordered information, each key/value pair in the set of ordered information having a plurality of keys, determine at which key the key/value pair diverges from the preceding or following keys, and increment the calculated cardinality value at the determined key part, and
wherein the means for storing the calculated statistic value store the incremented cardinality value.

15. The system of claim 14, wherein the means for performing remove a second key/value pair from the set of ordered information, determine a point at which the second key/value pair diverges from proximally located key/value pairs in the set of ordered information, and decrement the calculated cardinality value at the determined point, and
wherein the means for storing the calculated statistic value store the decremented cardinality value.

16. A computer program product comprising a computer readable medium having control logic stored therein for causing a computer to calculate a statistic of information change for a collection of information, the control logic comprising code for:
performing a real-time calculation of an actual statistic value of information change for the collection of information;
storing the calculated statistic value; and
updating the calculation of the statistic value when an item is added to or removed from the collection of information to accurately identify the effect of the change to the collection of information on the calculated statistic value.

17. The computer program product of claim 16, wherein the collection of information comprises an information database, and the statistic of information change comprises cardinality.

18. The computer program product of claim 17, further comprising control logic comprising code for:
using the calculated statistic value in query optimization for a database query.

19. An automated system of calculating a statistic of information change for a collection of information, the system comprising:
at least one processor;
a user interface functioning via the at least one processor, wherein the user interface is configured to receive a user input; and
a repository accessible by the at least one processor; wherein the at least one processor is configured to:
perform a real-time calculation of an actual statistic value of information change for the collection of information;
store the calculated statistic value; and
update the calculation of the statistic value when an item is added to or removed from the collection of information to accurately identify the effect of the change to the collection of information on the calculated statistic value.

20. The automated system of claim 19, wherein the collection of information comprises an information database, and the statistic of information change comprises cardinality, and wherein the processor is further configured to:
use the calculated statistic value in query optimization for a database query.
